(19) United States
(12) Patent Application Publication
(10) Pub. No.: US 2024/0329483 A1
(43) Pub. Date: Oct. 3, 2024

(54) DEVICE AND METHOD FOR CONTROLLING TINT OF A TRANSPARENT MEDIUM

(71) Applicant: LENOVO (SINGAPORE) PTE. LTD., SINGAPORE (SG)

(72) Inventors: Mark Delaney, Raleigh, NC (US); John C. Mese, Cary, NC (US); Nathan Peterson, Oxford, NC (US); Arnold Weksler, Raleigh, NC (US); Russell S. VanBlon

(21) Appl. No.: 18/192,084

(22) Filed: Mar. 29, 2023

(51) Int. Cl. G02F 1/163; G06V 20/50

(52) U.S. Cl. CPC G02F 1/163; G06V 20/50; G02F 2201/58

(57) ABSTRACT

A system for controlling light through a transparent medium is provided. The system can include at least one sensor configured to obtain context data within an environment of interest, and a controller configured to be in communication with the at least one sensor to obtain the context data. The system can also include an actuating device in communication with the controller and coupled to the transparent medium and configured to dynamically adjust the transparent medium to vary a characteristic of light passing through the transparent medium based on the context data.

### BACKGROUND

Embodiments herein generally relate to devices and methods for controlling the tint of a transparent medium, such as glass in windows or doors.

Window tinting is utilized to reduce glare, provide privacy, and enhance thermal properties of glass/windows. To provide tint, a thin film is applied to the glass that has chemical properties to allow the transmission of light and/or heat through the window and reduces the reflection of light from the film. To this end, light that results in glare can also be reduced. Common uses of tinted glass are presented in car windows, home windows, sunglasses, or the like.

In addition, electro-chemical processes exist that provide such a thin film that can be dynamically adjusted. For example, an electrochromic process can be utilized so that direct current (DC) voltage can be utilized to dynamically change the thin film from clear (e.g., no effect on incoming light) to tinted (e.g., effects a property of the incoming light such a reflection, color, etc.). In this manner, the thin film can be placed on a window of a home, vehicle, or the like, and a controller can dynamically adjust the DC voltage on the film to dynamically adjust the glass, including properties of the glass that effect how the light is transmitted through the thin film.

Meanwhile, electronic devices, such as laptop computers, mobile phones, personal digital assistants (PDAs), iPads, other computing devices, etc. have become part of many individuals' everyday life. Such electronic devices continue to be improved to make the experience of user as enjoyable as possible.

Artificial intelligence (AI) is also becoming common place for use in association with electronic devices. Whether to assist in making choices for an individual while shopping, customizing use, or just recognizing different individuals, AI is becoming more prominent in day-to-day settings. AI applications include AI algorithms that attempt to utilize numerous variables based on information received to make determinations regarding choices that are to be made. The AI algorithms utilize initial assumptions to determine the variables, and as individuals make choices, the variables are modified to reflect an individual's choice.

A need exists for improved control and operation of glass tinting technologies that are able to dynamically change properties of glass to control light that passes therethrough.

### SUMMARY

In accordance with embodiments herein, a system for controlling light through transparent medium is provided. The system can include at least one sensor configured to obtain context data within an environment of interest, and a controller configured to be in communication with the at least one sensor to obtain the context data. The system can also include an actuating device in communication with the controller and coupled to the transparent medium and configured to dynamically adjust a transparent medium related to light based on the context data.

Optionally, the controller includes a memory to store executable instructions, and one or more processors. When implementing the executable instructions, the one or more processors are configured to determine a condition within the environment of interest based on the context data, and command the actuating device to dynamically adjust the transparent medium based on the condition. In one aspect, the condition is a presence of a person within the environment of interest. In another aspect, the one or more processors are further configured to determine an electronic device in the environment of interest and command the actuating device to dynamically adjust the transparent medium also based on the electronic device determined to be in the environment of interest. In one example, to determine the condition an artificial intelligence algorithm utilizes the context data. In another example, the one or more processors are also configured to obtain auxiliary context data from a remote device and utilize the auxiliary context data to determine the condition using the artificial intelligence algorithm.

Optionally, the at least one sensor is on an electronic device in the environment of interest. In one aspect, the at least one sensor is one of a light detector, motion detector, or camera. In another aspect, the actuating device is configured to dynamically adjust a tint layer of the transparent medium. In one example, the transparent medium is part of at least one of a window, door or windshield. In another example, the actuating device is a direct current (DC) power supply.

In accordance with embodiments herein, a method is provided where under control of one or more processors including program instructions the method includes to obtain, with at least one sensor, context data within an environment of interest. The method can also include to determine a condition within the environment of interest based on the context data, and dynamically adjust, with an actuating device, a tint layer of transparent medium into the environment of interest based on the condition.

Optionally, the condition determined is a presence of a person within the environment of interest. In one aspect, the condition determined is a lack of a presence of a person within the environment of interest. In another aspect, the condition determined is identification of a person approaching the environment of interest. In one example, to determine the condition an artificial intelligence algorithm utilizes the context data. In another example, the one or more processors are also configured to obtain auxiliary context data from a remote device and utilize the auxiliary context data to determine the condition using the artificial intelligence algorithm.

In accordance with embodiment herein, a system for controlling light through a window of a dwelling is provided that includes a controller having a sensor for obtaining context data related to an environment of interest. The system also includes an actuating device in communication with the controller and coupled to the window and configured to dynamically adjust transparent medium of the window. The controller includes a memory to store executable instructions, and one or more processors. When implementing the executable instructions the one or more processors are configured to determine a condition related to the environment of interest based on the context data obtained from the sensor of the controller, and command the actuating device to dynamically adjust the transparent medium based on the condition determined.

Optionally, the system also includes an electronic device related to the environment of interest and in communication with the controller, the electronic device configured to obtain electronic device context data and communicate the electronic device context data to the controller. The one or more processors can be further configured to determine the condition based on the context data and the electronic device context data. In one aspect, to determine the condition based on the context data and the electronic device context data an artificial intelligence algorithm is utilized.

### BRIEF DESCRIPTION OF THE DRAWINGS

FIG. 1 illustrates a schematic block diagram of a system for controlling transparent medium tint, in accordance with embodiments herein.

FIG. 2 illustrates a schematic block diagram of an electronic device, in accordance with embodiments herein.

FIG. 3 illustrates a schematic block diagram of a controller of a system for controlling transparent medium tint, in accordance with embodiments herein.

FIG. 4 illustrates a block diagram of a process for controlling transparent medium tint, in accordance with embodiments herein.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment,” “in an embodiment” or the like in various places throughout this specification are not necessarily all referring to the same embodiment.

Furthermore, the described features, structures or characteristics may be combined in any suitable manner in one or more embodiments. In the following description, numerous specific details are provided to give a thorough understanding of the various embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

The terms “audio/video” and “AV” shall mean audio and/or video and shall include audio only, video only, or a combination of audio and video. For example, AV content may include 1) only audio content, with no video content 2) only video content, with no audio content, or 3) a combination of audio and video content. As another example, an AV output device may include a device to 1) output only audio content, and not video content, 2) output only video content, and not audio content, or 3) output a combination of audio and video content. As another example, an AV source may represent 1) a source that provides audio content but does not provide video content, 2) a source that provides video content but does not provide audio content, or 3) a source that provides both audio and video content.

The phrase “environment of interest” refers to a physical region in which a controller obtains context data for determining whether light characteristics of light going through a transparent medium should be varied. In one example one or more electronic devices and AV output devices are located in the environment of interest and in which AV content output by the AV output device(s) is perceived (e.g., heard, seen, felt) by individuals. By way of example, an environment of interest may refer to one or more rooms within a home, office or other structure. An environment of interest may or may not have physical boundaries. For example, an environment of interest instead be defined based upon a range over which individuals may perceive actions by electronic devices. When an electronic device is portable and/or handheld, an environment of interest associated with the electronic device may shift over time when the electronic device is moved. For example, an environment of interest surrounding a smart phone, tablet device or laptop computer moves with the smartphone, tablet device or laptop computer. An environment of interest surrounding an electronic device will shift each time the electronic device is relocated, such as when moved between different rooms of a home, office building or other residential or commercial structure, within a vehicle, or the like.

The term “network resource” refers to any device, system, controller, etc. that may monitor and communicate data and information that is related to an individual. Network resources can include servers, applications, remote processors, the cloud, etc. The network resource may communicate with an electronic device over a wire, through one or more wireless protocols including Bluetooth, GSM, infrared wireless LAN, HIPERLAN, 4G, 5G, satellite, or the like.

The phrase “transparent medium”, as used herein refers to any matter, substance, solid, pane, panel, etc. through which light can transmit. Transparent mediums can include glass, acrylics, plastics, chemical compounds with transmissive properties, or the like.

The phrase “tint layer”, as used herein refers to a substance in a transparent medium that has electrical, chemical, or mechanical properties that allow the substance to be dynamically adjusted to vary the light characteristics passing through the tint layer. In one example, the tint layer is electrochemically made so that DC voltage varies a property of the light passing through the tint layer.

The phrase “dynamically adjust” or “dynamically adjusting” or “dynamically adjusted” may be used interchangeably and when used herein refers to changing or varying in real time in response to a condition, or otherwise.

The phrase “real time” as used herein shall mean at the same time, or a time substantially contemporaneous, with an occurrence of another event or action. For the avoidance of doubt, as an example, a dynamically adjusted object or device is changed immediately, or within a second or two.

The term “obtains” and “obtaining”, as used in connection with data, signals, information and the like, include at least one of i) accessing memory of an external device or remote server where the data, signals, information, etc. are stored, ii) receiving the data, signals, information, etc. over a wireless communications link between the base device and a secondary device, and/or iii) receiving the data, signals, information, etc. at a remote server over a network connection. The obtaining operation, when from the perspective of a base device, may include sensing new signals in real time, and/or accessing memory to read stored data, signals, information, etc. from memory within the base device. The obtaining operation, when from the perspective of a secondary device, includes receiving the data, signals, information, etc. at a transceiver of the secondary device where the data, signals, information, etc. are transmitted from a base device and/or a remote server. The obtaining operation may be from the perspective of a remote server, such as when receiving the data, signals, information, etc. at a network interface from a local external device and/or directly from a base device. The remote server may also obtain the data, signals, information, etc. from local memory and/or from other memory, such as within a cloud storage environment and/or from the memory of a personal computer.

It should be clearly understood that the various arrangements and processes broadly described and illustrated with respect to the Figures, and/or one or more individual components or elements of such arrangements and/or one or more process operations associated of such processes, can be employed independently from or together with one or more other components, elements and/or process operations described and illustrated herein. Accordingly, while various arrangements and processes are broadly contemplated, described and illustrated herein, it should be understood that they are provided merely in illustrative and non-restrictive fashion, and furthermore can be regarded as but mere examples of possible working environments in which one or more arrangements or processes may function or operate.

A device and methods are provided for controlling characteristics of light into an environment of interest through a transparent medium. The transparent medium, that can be a window, door panel, windshield, or the like includes a tint layer that can be dynamically adjusted in real time to vary one or more of the characteristics of the light. For example, direct current voltage can be applied to the transparent medium to cause an electrochemical reaction of the tint layer, such as causing the tint layer to be more reflective, less reflective, increase light or heat absorption, decrease light or heat absorption, vary opacity, vary wavelength, color, or the like. A controller can then include sensors to determine characteristics, parameters, conditions, etc. of the environment of interest to dynamically adjust the tint layer of the transparent medium to improve the light qualities in the environment of interest. For example, if an electronic device such as a television is being utilized in the environment of interest, and glare through a window is showing up on the screen of the television, such glare use of the television and glare can be detected and the tint layer dynamically adjusted to reduce or eliminate the glare projecting onto the television.

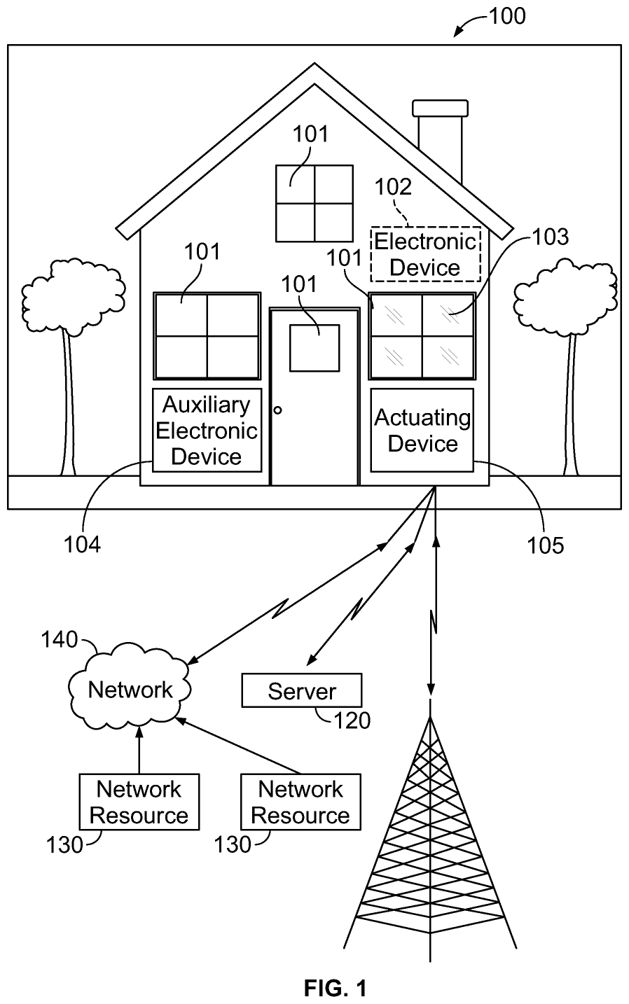

FIG. 1 is a block diagram of a system 100 for controlling the tint of a transparent medium 101, in accordance with embodiments herein. In one example, the transparent medium is glass. In another example embodiments the transparent medium 101 can be a window of a dwelling such as a home, office building, or the like, the window on a vehicle, etc. In one example, the transparent medium includes a tint layer 103 that is configured to dynamically adjust at least one property of the transparent medium 101 to vary the light transmitted through the tint layer in response to actuation by an actuating device 105. The at least one property of light transmitted through the tint layer can include the reflection of light from the tint layer compared to the transparent medium, the type of light, wavelength of light, or range of wavelengths of light transmitted through the light, the heat passing through the tint layer 103 compared to the transparent medium, the polarization of the light, or the like.

In one example, the tint layer 103 can be dynamically adjusted by the actuating device 105 to dynamically adjust the at least one property of light. In one example, the tint layer is electrochemically made such that when a voltage, including a DC voltage, is applied from an actuating device 105, the tint layer varies a property of the light through the tint layer 103. In this manner, the actuating device 105 can be any device that supplies DC voltage such as a battery, electric motor, or the like. In one example, the amount of voltage applied to the tint layer is proportional to the variance of the property of light. For example, when more voltage is applied, more light may be prevented from being reflected compared to when less voltage is applied. In another example, when more voltage is applied a greater range of wavelengths may be blocked such that the greater the voltage the less wavelengths of light that are permitted to be transmitted through the tint layer compared to when less voltage is provided. In yet another example, the amount of glare can be varied based on the amount of voltage provided. In each example, when voltage is varied, the characteristic of light is also varied. In other embodiment, instead of a variance, the voltage includes a threshold voltage where when below the threshold voltage, the tint layer 103 does not vary or change properties of light, whereas above the threshold voltage at least one property of light is varied.

The system 100 includes an electronic device 102, one or more auxiliary electronic devices 104, and one or more servers 120. By way of example, the electronic device 102 may be a mobile device, such as a cellular telephone, smartphone, tablet computer, personal digital assistant, laptop/desktop computer, gaming system, a media streaming hub device, IoT device, or other electronic terminal that includes a user interface and is configured to access a network 140 over a wired or wireless connection. As non-limiting examples, the electronic device 102 may access the network 140 through a wireless communications channel and/or through a network connection (e.g. the Internet). The electronic device 102 in one embodiment is in communication with a network resource 130 via the network. The network resource 130 can be a server, application, remote processor, the cloud, etc. In one example, the network resource 130 is one or more processors of an auxiliary electronic device 104 that communicates over the network 140 with the electronic device 102. The network 140 may represent one or more of a local area network (LAN), a wide area network (WAN), an Intranet or other private network that may not be accessible by the general public, or a global network, such as the Internet or other publicly accessible network.

Additionally or alternatively, the electronic device 102 may be a wired or wireless communication terminal, such as a desktop computer, laptop computer, network-ready television, set-top box, and the like. The electronic device 102 may be configured to access the network using a web browser or a native application executing thereon. In some embodiments, the electronic device 102 may have a physical size or form factor that enables it to be easily carried or transported by a user, or the primary electronic device 102 may have a larger physical size or form factor than a mobile device.

The electronic device 102 includes a first sensor 106 and a second sensor 108 that each obtain information related to a user, the local environment of interest, the transparent medium 101, etc. The first sensor 106 and second sensor 108 may be beam-forming microphones, passive infrared sensors, time-of-flight, or LiDAR sensors, high-resolution red green blue (RGB) cameras, high-resolution RGB wide-angle camera, light level sensors, temperature sensors, etc. While only a first sensor 106 and second sensor 108 are illustrated, in other examples three or more sensors are provided. The first sensor 106 can obtain a first type of information, while the second sensor 108 can obtain a second type of information. The first type of information in one example is auditory from a first sensor 106 that is a microphone, while the second type of information is visual from a second sensor 108 that is a camera. Similarly the first or second types of information can be temperature based, infrared, haptic, or the like. Still, each of the first sensor 106 and second sensor 108 can provide a different type of information that may be utilized by the one or more processors, a tint application, an AI application, a network AI application, or the like.

The sensors 106, 108 can obtain context data such as characteristics of interest related to an environment of interest, user, etc. and based on the characteristics of interest, determine a condition in the environment of interest and actuate the tint layer 103 with the actuating device 105 to dynamically adjust the tint of transparent medium in the environment of interest based on the condition. For example, a first sensor can be a security camera that obtains characteristics of interest that indicate the condition that an unknown person is approaching a home. A second sensor, such as a door bell could also detect the presence of an unknown person (e.g., a delivery person). Upon detection of the unknown person via the first sensor 106 and/or second sensor 108 a tint application could automatically, and dynamically in real time actuate the actuating device 105 to tint the transparent medium of the front windows, and/or door window, to prevent the unknown person from seeing inside the home. In this manner, additional privacy for those in the home are provided and a unsavory person that may want to break into the home would not be able to gather any information regarding whether a person was in the home.

In another example, one or more sensors 106, 108 could detect the condition that a bathroom light is turned on at midnight and that a user enters a bathroom of the house. Alternatively, if a timer is not present, an outside sensor can detect the sun has set, thus making it easier for an unknown person from seeing into the bathroom from the outside. As a result, the tint application tints the windows again for privacy purposes.

In addition to dynamically adjusting the tint of transparent medium/windows to provide tint, in other examples, transparent medium may be tinted, and the tint application can determine to dynamically adjust the tint layer of the transparent medium by untinting the transparent medium layer. For example, if a condition is determined that no user is detected in a room that has plant life for a predetermined period of time, and sunlight is detect, the tint applicant can stop the operation of the actuating device 105 to stop providing a DC voltage to untint windows that are currently tinted to allow sunlight for the plants. In one such example, the tint application includes settings, such as plant setting, security settings, working settings, privacy settings, or the like where the use selects determined events that if they occur, then the tint of windows in an environment of interest are varied accordingly. As another example, when a television is detected to be on, windows in the room having the television can be automatically tinted in real time to reduce glare on the television, or glare in the eyes of a user in the environment of interest attempting to watch the television.

In each example, when determining whether a determined condition, threshold, occurrence, or the like is occurring an artificial intelligence (AI) algorithm, or AI application can be used to make such determinations. To this end, to determine that a person is in a bathroom, a timer, motion sensor, temperature sensor, etc. can all provide characteristics of interest that represent variables used to determine whether the threshold, condition, occurrence, etc. (e.g., person in the bathroom, no one home, unknown person outside a home, etc.) has been reached. In one example, the AI application, and/or tint application can communicate over the network to a remote database related to the characteristics of interest resulting in accurate determinations of the determined condition, threshold, occurrence. By using data and information from numerous AI or tint applications, more accurate determinations can be made improving functionality.

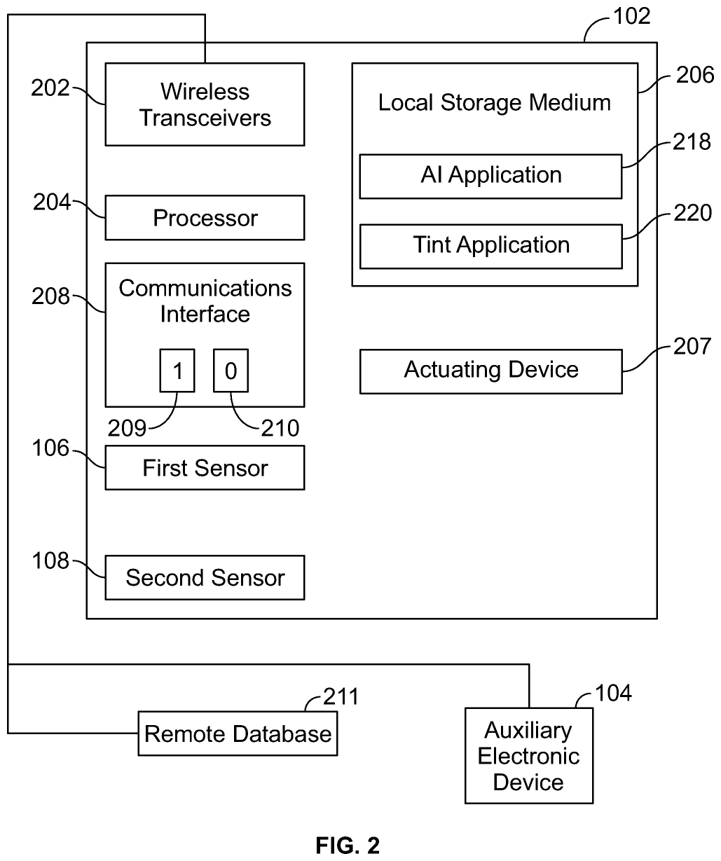

FIG. 2 illustrates a simplified block diagram of the electronic device 102 of FIG. 1 in accordance with an embodiment. The electronic device 102 includes components such as one or more wireless transceivers 202, one or more processors 204 (e.g., a microprocessor, microcomputer, application-specific integrated circuit, etc.), and one or more local storage medium (also referred to as a memory portion) 206.

Each transceiver 202 can utilize a known wireless technology for communication. Exemplary operation of the wireless transceivers 202 in conjunction with other components of the primary electronic device 102 may take a variety of forms and may include, for example, operation in which, upon reception of wireless signals, the components of primary electronic device 102 detect communication signals from auxiliary electronic devices 104 and the transceiver 202 demodulates the communication signals to recover incoming information, such as responses to inquiry requests, voice and/or data, transmitted by the wireless signals. The one or more processors 204 format outgoing information and convey the outgoing information to one or more of the wireless transceivers 202 for modulation to communication signals. The wireless transceiver(s) 202 convey the modulated signals to a remote device, such as a cell tower or a remote server (not shown).

The local storage medium 206 can encompass one or more memory devices of any of a variety of forms (e.g., read only memory, random access memory, static random access memory, dynamic random access memory, etc.) and can be used by the one or more processors 204 to store and retrieve data. The data that is stored by the local storage medium 206 can include, but need not be limited to, operating systems, applications, obtained context data, and informational data. Each operating system includes executable code that controls basic functions of the device, such as interaction among the various components, communication with external devices via the wireless transceivers 202, and storage and retrieval of applications and context data to and from the local storage medium 206. In one example, the transceivers can be in communication with an actuating device 207 that operates to change the tint of transparent medium. In one example, the actuating device 207 supplies a DC voltage to dynamically adjust the tint of the transparent medium. In addition, the transceivers can also be in communication with a remote database 211 to communicate context data and determinations made by the one or more processors 202 and to obtain auxiliary context data from other systems.

The electronic device 102 in one embodiment also includes a communications interface 208 that is configured to communicate with a network resource (FIG. 1). The communications interface 208 can include one or more input devices 209 and one or more output devices 210. The input and output devices 209, 210 may each include a variety of visual, audio, and/or mechanical devices. For example, the input devices 209 can include a visual input device such as an optical sensor or camera, an audio input device such as a microphone, and a mechanical input device such as a keyboard, keypad, selection hard and/or soft buttons, switch, touchpad, touch screen, icons on a touch screen, a touch sensitive areas on a touch sensitive screen and/or any combination thereof. Similarly, the output devices 210 can include a visual output device such as a liquid crystal display screen, one or more status indicators that may be light elements such as light emitting diodes, an audio output device such as a speaker, alarm and/or buzzer, and a mechanical output device such as a vibrating mechanism. The display may be touch sensitive to various types of touch and gestures. As further examples, the output device(s) 210 may include a touch sensitive screen, a non-touch sensitive screen, a text-only display, a smart phone display, an audio output (e.g., a speaker or headphone jack), and/or any combination thereof.

The electronic device 102 also includes the first sensor 106, a second sensor 108, an artificial intelligence (AI) application 218, and tint application 220 as described in relation to FIG. 1. All of these components can be operatively coupled to one another, and can be in communication with one another, by way of one or more internal communication links, such as an internal bus. The first sensor 106 and the second sensor 108 both function to obtain a first type of information and a second type of information related to the user or an environment of interest. The types of information can include visual, auditory, haptic, infrared, or the like. The information may include a first condition detected when the first sensor is an image sensor such as the presence of the user at the electronic device 102. Alternatively, the information may include a second condition detected when the second sensor is a microphone such as the determination that additional individuals are in an environment of the interest through voice recognition, the determination of spoken words, or the like.

In one example, by obtaining information related to the environment of interest, the one or more processors 204 can determine a profile related to an individual to provide a setting for the first sensor 106 and second sensor 108. In particular, a profile may be related to an individual, including the operating settings for the first sensor 106 and second sensor 108 based on the conditions within the environment of interest. To this end, a first individual may have a first profile, while a second individual has a second profile. Alternatively, the first individual may have a first profile for when the individual is in their home compared to a second profile for when the individual is in an office. Similarly, in another example, a first individual can have a first profile that is typically utilized, and a second profile for when an application, such as a meeting application launches on the electronic device 102, or when an electronic device such as a television is in use. As such, each profile has different settings for the first sensor 106 and second sensor 108 operating states.

The AI application 218 and the tint application 220 in one embodiment are stored within the storage medium 206 and each include executable code. Both the AI application 218 and the tint application 220 obtain information, including context data, from the first sensor 106, second sensor 108, along with other sensors, information input by a user, etc. For example, the AI application 218 may obtain the context data related to the user and the environment of the user, or environment of interest, to make determinations about the use of the electronic device 102 such as a television to improve the experience of using the electronic device 102. The AI application 218 may also receive auxiliary context data from the remote database 211 related to similarly situated systems and environments to provide more accurate calculations related to the context data of the environment of interest.

The tint application 220 in one example is accessed through the input device 209. In particular, the tint application 220 determines operating states of the first sensor 106, the second sensor 108, and any other sensor utilized by the electronic device 102 or auxiliary electronic devices within the environment of interest that communicate with the electronic device 102. The tint application 220 obtains context data such as characteristics of interest from the first sensor 106 and second sensor 108 that can be utilized to make determination regarding how to operate the actuating device 207 to dynamically adjust the tint of the transparent medium or windows in the environment of interest that can be operated and controlled by the electronic device. In one example the electronic device 102 is a smart phone that includes an application that includes the tint application that controls the operation of the tint layer with the transparent medium. Alternatively, the electronic device 102 can be a controller that can be utilized to control or operate the tint of the transparent medium. The controller can include sensors, or can be in communication with other electronic devices in the environment of interest that have sensors to obtain the characteristics of interest of the environment of interest, characteristics of interest of a user, etc.

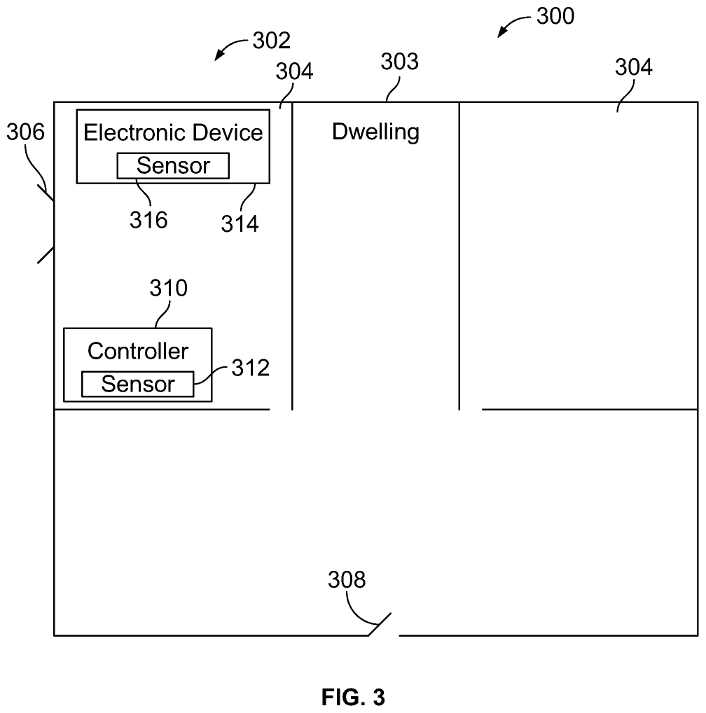

FIG. 3 illustrates an example environment of interest 300 in which a system 302 for dynamically adjusting the tint of a transparent medium may be utilized. In one example, the system 302 is one of the systems of FIG. 1 or 2, or alternatively utilizes at least one component illustrated in FIG. 1 or 2. The environment of interest of FIG. 3 is a home or dwelling 303 that includes multiple different rooms 304, and can include plural components of the transparent medium, including transparent medium in windows 306 or transparent medium in doors 308. While in this example a home is illustrated, in other example embodiments the dwelling 303 may be an office building, green house, garage, barn, or the like. While in this example a dwelling is illustrated, in other example embodiments, instead of a dwelling, the transparent medium may be a competent of a vehicle such as a window or windshield.

Within the dwelling 303 the system 302 can include at least one controller 310 and at least one sensor 312. The at least one sensor can detect context data such as light levels, temperature, time of day, sound, or the like. To this end, in example embodiments the at least one sensor can be a light detector, camera, infrared camera, digital camera, microphone, thermostat, thermometer, or the like. In addition to the at least one sensor 312, the controller 310 can be in communication with electronic devices 314 within the dwelling. In one example, the controller can determine all electronic device connected to a network related to the dwelling and communication pathways are provided accordingly. To this end, the electronic devices 314 may include electronic device sensors 316 such as light sensors, cameras, microphones, global satellite positioning systems, or the like that can provide additional context data such as environmental characteristics related to the dwelling. Then, based on these environmental characteristics, a tint application can make determinations related to dynamically adjusting the tint of transparent medium such as glass of the windows 306, doors 308, and/or both using an actuating device (not shown).

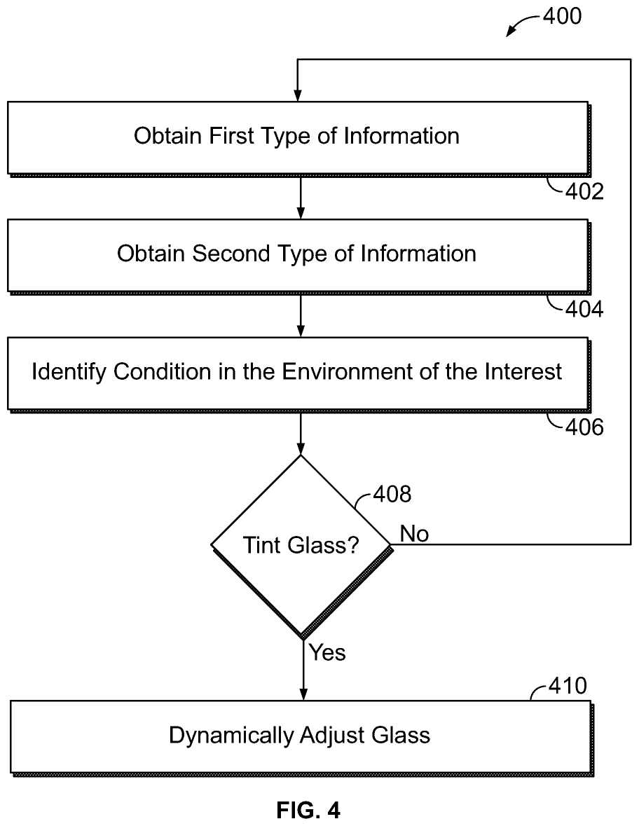

FIG. 4 illustrates a block diagram of a method 400 of controlling the tint of transparent medium in an environment of interest. The method 400 may be implemented utilizing the system and electronic device of FIGS. 1 and 2.

At 402, one or more processors obtain a first type of information, or first context data, regarding an environment of interest such as environmental characteristics. The one or more processors may obtain the first type of information from a first sensor, have the information input into the electronic device or the like. The first type of context data can include data obtained utilizing auditory, visual, haptic, infrared, etc. methodologies. The environment of interest can be a room, a dwelling, a home, an office building, or the like.

At 404, the one or more processors obtain a second type of information, or second context data, regarding an environment of interest, such as user characteristics. The one or more processors may obtain the second type of information from a second sensor, have the information input into the electronic device or the like. The second type of context data can include data obtained utilizing auditory, visual, haptic, infrared, etc. methodologies. The environment of interest can be a room, a home, an office building, a dwelling, or the like.

At 406, the one or more processors identify a condition present in the environment of interest based on context data. The condition present in one embodiment can be the existence of an individual in front of the electronic device such as a television. In other embodiments, the condition present can be the existence of an unknow person, the lack of presence of individuals in an environment, or the like.

At 408, one or more processors determine whether the tint of transparent medium in the environment of interest should be varied. Based on context data obtained by the sensors, including from sensors of the system or sensors of electronic devices within an environment of interest and in communication with the system, a determination related to a condition in the environment of interest is made. For example, the condition could be presence of a person or user watching television in the environment of interest, or reading a book, or driving a vehicle, etc. In another example, the condition could be that no one is within an environment of interest. In yet another example, the condition could be that an unidentified individual is approaching or within the environment of interest. In each instance, variations to the tint of transparent medium in the environment of interest, including to windows in the environment of interest can be desired. In example embodiments, an AI application can be utilized to make these determinations to provide additional accuracy in making determinations.

If at 408, a determination is made that the tint needs to be varied, then at 410 one or more processors command an actuating device to dynamically adjust the transparent medium to vary at least one light characteristic of the light passing through the transparent medium based on the context data related to the environment of interest. In example embodiments the actuating device can be a DC power supply, DC-DC converter, an AC-DC converter, or the like. To this end, the actuating device may supply a constant DC current, or a variable DC current that is used to dynamically adjust the tint or other characteristics of light related to the transparent medium. Consequently, a system that automatically adjusts the tint of transparent medium in an environment of interest based on the activities, presence, etc. of individuals in the environment of interest is provided. As a result, security, energy efficiency, comfort, etc. are enhanced and all of the stated problems are overcome.

As will be appreciated, various aspects may be embodied as a system, method or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable data storage device(s) having computer (device) readable program code embodied thereon.

Any combination of one or more non-signal computer (device) readable mediums may be utilized. The non-signal medium may be a data storage device. The data storage device may be, for example, an electronic, magnetic, optical, electromagnetic, infrared, or semiconductor system, apparatus, or device, or any suitable combination of the foregoing. More specific examples of a data storage device may include a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface and a storage device for storing code may store the program code for carrying out the operations and provide this code through the network interface via a network to a second device having a second processor for execution of the code on the second device.

Aspects are described herein with reference to the figures, which illustrate example methods, devices and program products according to various example embodiments. These program instructions may be provided to a processor of a general purpose computer, special purpose computer, or other programmable data processing device or information handling device to produce a machine, such that the instructions, which execute via a processor of the device implement the functions/acts specified. The program instructions may also be stored in a device readable medium that can direct a device to function in a particular manner, such that the instructions stored in the device readable medium produce an article of manufacture including instructions which implement the function/act specified. The instructions may also be loaded onto a device to cause a series of operational steps to be performed on the device to produce a device implemented process such that the instructions which execute on the device provide processes for implementing the functions/acts specified.

The units/modules/applications herein may include any processor-based or microprocessor-based system including systems using microcontrollers, reduced instruction set computers (RISC), application specific integrated circuits (ASICs), field-programmable gate arrays (FPGAs), logic circuits, and any other circuit or processor capable of executing the functions described herein. Additionally or alternatively, the modules/controllers herein may represent circuit modules that may be implemented as hardware with associated instructions (for example, software stored on a tangible and non-transitory computer readable data storage device, such as a computer hard drive. ROM, RAM, or the like) that perform the operations described herein. The above examples are exemplary only, and are thus not intended to limit in any way the definition and/or meaning of the term “controller.” The units/modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

What is claimed is:

1. A system for controlling light through a transparent medium, comprising:
at least one sensor configured to obtain context data within an environment of interest;
a controller configured to be in communication with the at least one sensor to obtain the context data;
an actuating device in communication with the controller and coupled to the transparent medium and configured to dynamically adjust a characteristic of the transparent medium related to light based on the context data; and
the controller comprising:
a memory to store executable instructions; and
one or more processors, when implementing the executable instructions, to:
determine a condition related to a person within the environment of interest based on the context data; and
command the actuating device to dynamically adjust the characteristic of the transparent medium based on the condition.

2. The system of claim 1, wherein the one or more processors are further configured to determine an electronic device in the environment of interest; and
command the actuating device to dynamically adjust the characteristic of the transparent medium also based on the electronic device determined to be in the environment of interest.

3. The system of claim 1 wherein to determine the condition an artificial intelligence algorithm utilizes the context data.

4. The system of claim 3, wherein the one or more processors are also configured to obtain auxiliary context data from a remote device and utilize the auxiliary context data to determine the condition using the artificial intelligence algorithm.

5. The system of claim 1, wherein the at least one sensor is on an electronic device in the environment of interest.

6. The system of claim 1, wherein the at least one sensor is one of a light detector, motion detector, or camera.

7. The system of claim 1, wherein the actuating device is configured to dynamically adjust a tint layer of the transparent medium.

8. The system of claim 1, wherein the transparent medium is part of at least one of a window, door or windshield.

9. The system of claim 1, wherein the actuating device is a direct current (DC) power supply.

10. A method, comprising:
under control of one or more processors including program instructions to:
obtain, with at least one sensor, context data within an environment of interest;
determine a condition within the environment of interest based on the context data; and
dynamically adjust, with an actuating device, a tint layer of a transparent medium to vary light within the environment of interest based on the condition.

11. The method of claim 10, wherein the condition determined is a presence of a person within the environment of interest.

12. The method of claim 10, wherein the condition determined is a lack of a presence of a person within the environment of interest.

13. The method of claim 10, wherein the condition determined is identification of a person approaching the environment of interest.

14. The method of claim 10, wherein to determine the condition an artificial intelligence algorithm utilizes the context data.

15. The method of claim 14, wherein the one or more processors are also configured to obtain auxiliary context data from a remote device and utilize the auxiliary context data to determine the condition using the artificial intelligence algorithm.

16. A system for controlling light through a window of a dwelling, comprising:
a controller having a sensor for obtaining context data related to an environment of interest; and
an actuating device in communication with the controller and coupled to the window and configured to dynamically adjust a transparent medium of the window;
the controller comprising:
a memory to store executable instructions; and
one or more processors, when implementing the executable instructions, to:
determine a condition related to the environment of interest based on the context data obtained from the sensor of the controller; and
command the actuating device to dynamically adjust the transparent medium based on the condition determined.

17. The system of claim 16, further comprising an electronic device related to the environment of interest and in communication with the controller, the electronic device configured to obtain electronic device context data and communicate the electronic device context data to the controller;
the one or more processors further configured to:
determine the condition based on the context data and the electronic device context data.

18. The system of claim 17, wherein to determine the condition based on the context data and the electronic device context data an artificial intelligence algorithm is utilized.

19. The system of claim 16, wherein the condition determined is a lack of a presence of a person within the environment of interest.

20. The method of claim 16, wherein the condition determined is identification of a person approaching the environment of interest.
